(19) United States
(12) Patent Application Publication
(10) Pub. No.: US 2008/0216372 A1
(43) Pub. Date: Sep. 11, 2008

(54) Identification Bracelet

(76) Inventor: Chin-Chang Lee, Yuan Li Chen (TW)

Correspondence Address: CHIN-CHANG LEE, NO. 6, LANE 174, CHUNG SHAN RD., YUAN LI CHIEN (R.O.C.), 358, TW

(21) Appl. No.: 11/871,163

(22) Filed: Oct. 12, 2007

(30) Foreign Application Priority Data
Mar. 6, 2007 (TW) 096203674

(51) Int. Cl. G09F 3/00

(52) U.S. Cl. 40/633

(57) ABSTRACT

An identification bracelet is disclosed in the invention, which comprises a main body with different colors disposed at two surfaces thereof, and the bracelet includes a serrated fastening portion and fastening slits. The main body has a first and a second area for displaying information respectively disposed on the two surfaces thereof; the two surfaces may be selectively used according to the gender of wearers. Moreover, the bracelet may be folded into a loop and secured around the wrist or ankle of patients or deceased persons; the serrated fastening portion is inserted through the fastening slits so as to secure the bracelet from loosening, which allows the bracelet to be utilized conveniently.

### 1. FIELD OF THE INVENTION

The invention relates to an identification bracelet, and more particularly, to an identification bracelet applicable in the fields of healthcare or funeral service.

### 2. THE PRIOR ARTS

As shown in FIG. 5, the identification bracelet of prior arts comprises a strap (20) that has an area for displaying information (21) at an end section thereof, and the area for displaying information (21) allows healthcare staff to fill in information about the patient who wears the bracelet. The area for displaying information (21) has a film (22) disposed at the rear end thereof, and the film (22) has an adhesive (220) disposed therein. To apply the bracelet, the strap (20) is encircled around the wrist of a patient, and then the front section of the strap (20) is inserted through the film (22) disposed at the rear end of the strap (20), so that the part of the strap (20) that has been inserted through the film (22) may be attached to the adhesive (220) by pressing the film (22). Referring to FIG. 6, the identification bracelet comprises a strap (20) that has an area for displaying information (21) at an end section thereof, and the area for displaying information (21) allows healthcare staff to fill in information about the patient who wears the bracelet. The strap (20) has a plurality of aligning holes (23) disposed thereon, and a male button (24) is disposed at the end of the strap (20), whereas a female button (240) is correspondingly disposed in relation to the male button (24), so that the two buttons may be fastened together when facing each other. To apply the bracelet, the strap (20) is encircled around the wrist of a patient, and then the strap (20) may be secured from loosening by aligning the male button (24) to one of the aligning holes (23) on the strap (20), and subsequently folding the female button (240) to the opposite of the male button (24), in order to allow the buttons to fasten together.

Although the identification bracelets disclosed in FIGS. 5 and 6 serve the purpose of securely fitting on patients, they still have the following disadvantages:
1. Limited function: The aforesaid bracelets are designed for a single gender, which means the gender of the wearers cannot be distinguished by using the bracelet only.
2. High manufacturing cost: The bracelet must have holes disposed on its strap first, followed by having the end section of the strap disposed with a male button and a female button for securing the strap, which makes the strap costly and laborious to manufacture.
3. Inconvenience: For securing the bracelet, the male button needs to be aligned to the holes on the strap first, and then the male and the female buttons at the end of the strap must be fastened together. However, once the male and the female buttons are fastened together, it is difficult to separate the buttons from each other, which causes inconvenience to the healthcare staff.
4. Limited usage: For the bracelet that is secured by inserting the strap through the film at the rear end of the strap, and then attaching the strap to the adhesive inside of the film; it easily becomes unusable after a period of use because the adhesive loses stickiness. Consequently, the bracelet can no longer be secured from loosening, which causes inconvenience to the healthcare staff.

### DESCRIPTION OF THE INVENTION

In light of the disadvantages mentioned above, an identification bracelet is disclosed in this invention to eliminate the problems of limited usage and inconvenience found in the identification bracelets of prior arts.

A primary objective of the invention is to propose an identification bracelet that comprises a main body having different colors at two surfaces thereof, a serrated fastening portion, and fastening slits. Moreover, the main body includes a first area for displaying information and a second area for displaying information at two surfaces thereof, which allows the bracelet to be selectively used according to the gender of wearers. The bracelet may be encircled around the wrist or ankle of patients or deceased persons, and then the serrated fastening portion is inserted through the fastening slits so as to secure the bracelet from loosening; or a signal-transmitting device may be disposed in the first and the second areas for displaying information of the main body, which allows the bracelet to be utilized conveniently.

### DETAILED DESCRIPTION OF PREFERRED EMBODIMENTS

To allow the structure and purposes of the invention to be better understood, the preferred embodiments of the invention are described in details and accompanied by relevant drawings below. However, the preferred embodiments merely serve the purpose of elucidation, and is not to be used to limit the scope of the invention.

FIGS. 1 and 2 are schematic views that show the identification bracelet of the invention in either a three-dimensional or a dissected state, comprising:

a bracelet (10), which includes a main body (100) having different colors disposed at two surfaces thereof, and the main body (100) has a first area for displaying information (101) and a second area for displaying information (102) respectively disposed on the two surfaces thereof, so that the bracelet may be selectively used according to the gender of wearers;

wherein the bracelet (10) also comprises a serrated fastening portion (11) and two fastening slits (12); the bracelet (10) may be folded into a loop, and then followed by inserting the serrated fastening portion (11) through the two fastening slits (12) in order to secure the bracelet (10) from loosening; for the two fastening slits (12), one is formed with a longer opening, and the other is formed with a shorter opening;

The combination of the aforesaid structure forms the identification bracelet of the invention.

FIGS. 3 and 4 are the schematic views that show the identification bracelet of the invention in states of usage. The bracelet (10) is encircled around the wrist or ankle of a patient or a deceased person, and the serrated fastening portion (11) is inserted through the two fastening slits (12) in order to secure the bracelet (10) from loosening. The bracelet (10) has a first area for displaying information (101) and a second area for displaying information (102) disposed on a upper and a lower surface, respectively; and the bracelet (10) has different colors disposed on the two surfaces thereof, so that the two surfaces may be selectively used according to the gender of wearers. For the two fastening slits (12), one of the slits is formed with a longer opening, and the other is formed with a shorter opening; when the serrated fastening portion (11) is inserted through the two fastening slits (12), the bracelet (10) is effectively secured from loosening, and the bracelet (10) may be easily unfastened by removing the fastening portion (11) from the two fastening slits (12), which allows the bracelet (10) to be utilized conveniently.

Referring to FIG. 5, which shows a preferred embodiment of the identification bracelet according to the invention; wherein a signal-transmitting device (13) may be adhered or enclosed into the first and the second areas for displaying information (101), (102) of the main body (10). The signal-transmitting device (13) may be RFID (Radio-Frequency Identification) or other signal transmitters, and may transmit signals about the information of patients or deceased persons, so that healthcare staff or staff of funeral service may obtain the information about particular patients or deceased persons conveniently and quickly, and thus making the identification bracelet of the invention more useful.

The present invention has been described with a preferred embodiment thereof and it is understood that many changes and modifications to the described embodiment can be carried out without departing from the scope and the spirit of the invention that is intended to be limited only by the appended claims.

### BRIEF DESCRIPTION OF DRAWINGS

The structure and the technical means adopted by the present invention to achieve the above and other objectives can be best understood by referring to the following detailed description of the preferred embodiments and the accompanying drawings, wherein:

FIG. 1 is a schematic view that shows the invention in a three-dimensional state.

FIG. 2 is a schematic view that shows the invention in a dissected state.

FIG. 3 is a schematic view that shows the invention in a state of usage.

FIG. 4 is a schematic view that shows the invention in another state of usage

FIG. 5 is a view that shows an identification bracelet of a prior art.

FIG. 6 is a view that shows an identification bracelet of another prior art.

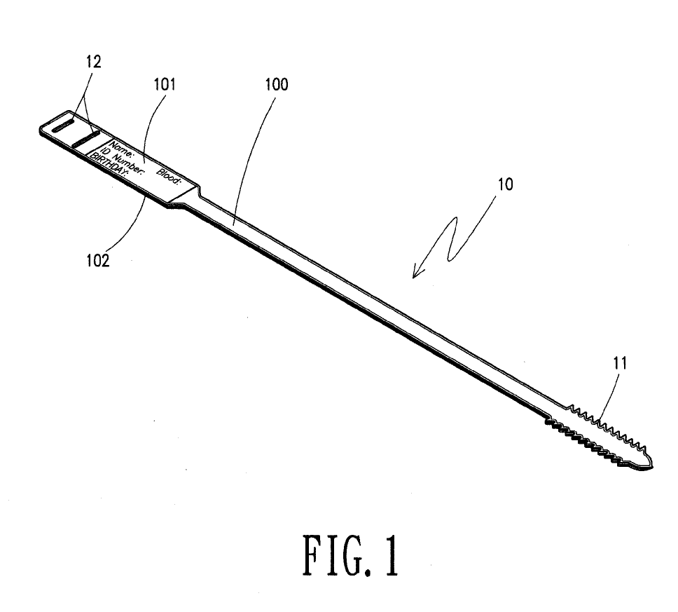

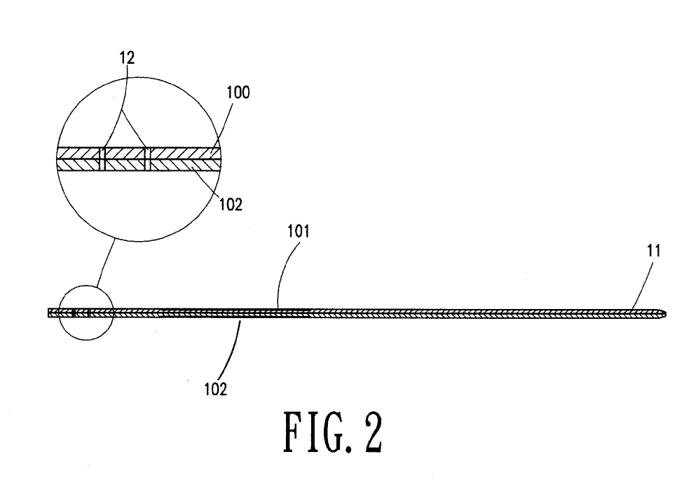

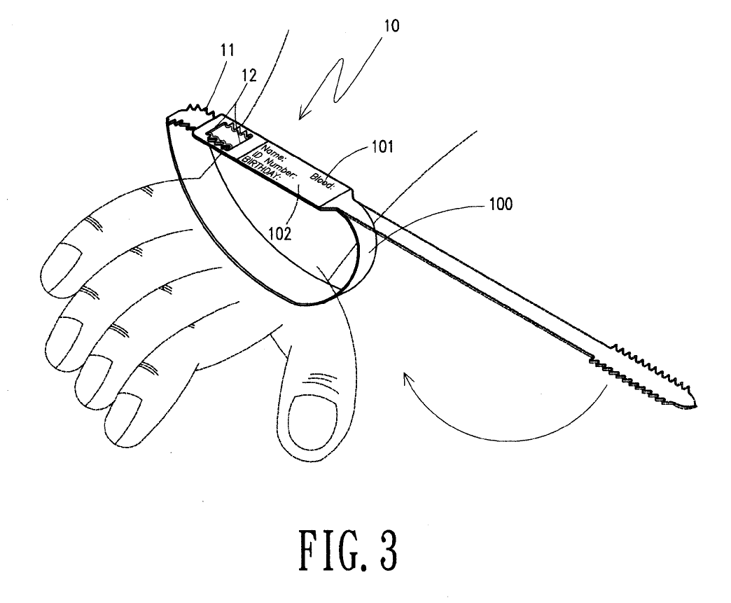

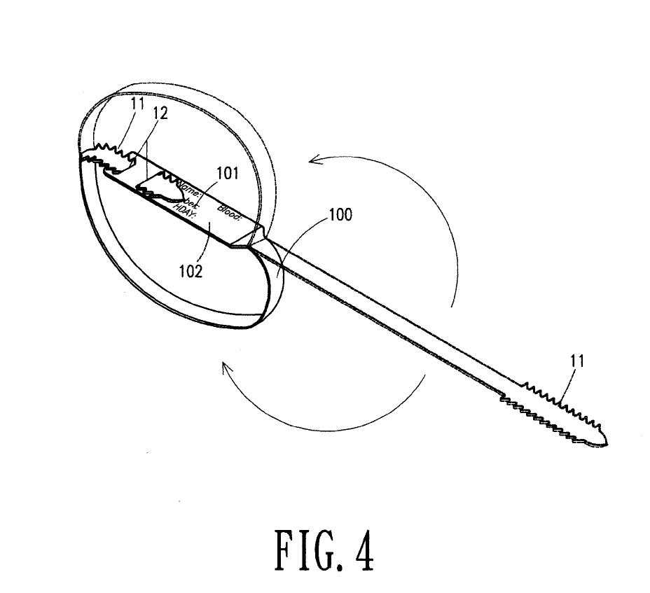

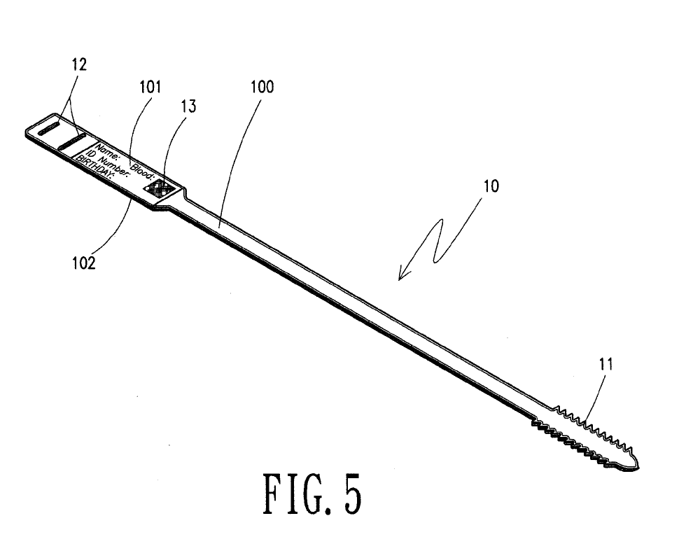

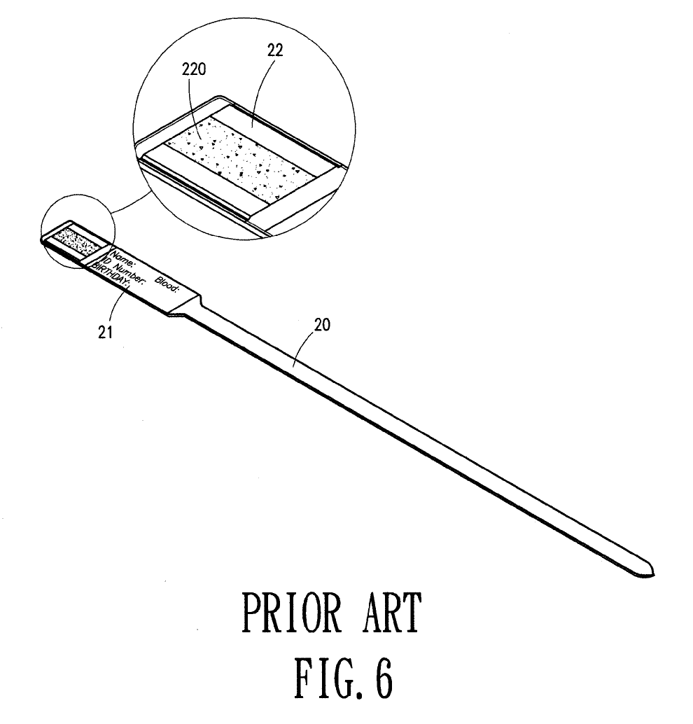

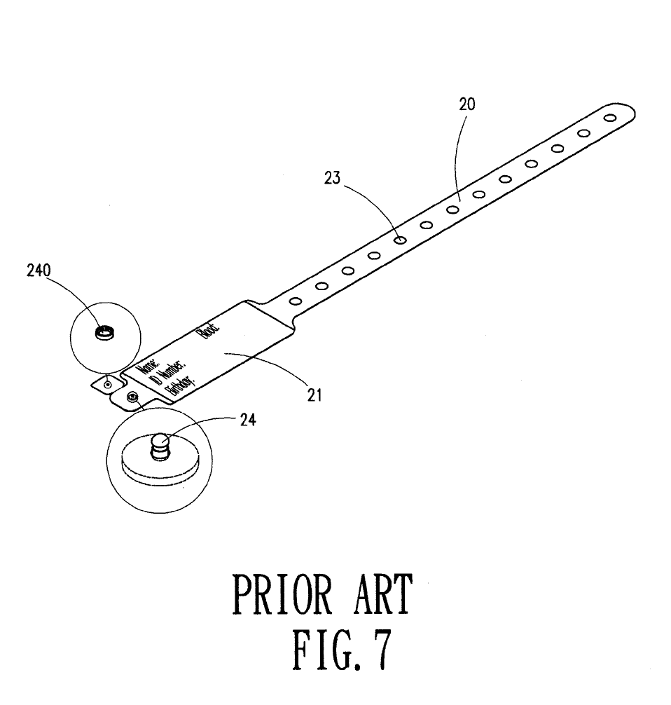

### BRIEF DESCRIPTION OF NUMBERALS

(1) The drawing representative of this invention is: FIG. (1)
(2) A Brief Description of the Numerals Used in the Invention:
   (10) bracelet
   (11) serrated fastening portion
   (12) fastening slits
   (13) signal-transmitting device
   (100) main body
   (101) first area for displaying information
   (102) second area for displaying information

What is claimed is:

1. An identification bracelet, comprising:
a bracelet having a serrated fastening portion and fastening slits, the bracelet may be folded into a loop so as to insert the serrated fastening portion through the fastening slits, and thus securing the bracelet in the shape of a loop.

2. The identification bracelet of claim 1, wherein one of the fastening slits is formed with a longer opening, and the other slit is formed with a shorter opening;
when the serrated fastening portion is inserted through the two fastening slits, the bracelet is effectively secured from loosening.

3. An identification bracelet, comprising:
a bracelet having a main body with different colors disposed at two surfaces thereof, the two surfaces may be selectively used according to the gender of wearers, and the main body may be folded into a loop and secured.

4. An identification bracelet, comprising:
a bracelet having a main body with different colors disposed at two surfaces thereof, the two surfaces may be selectively used according to the gender of wearers, and the main body further includes a signal-transmitting device; the main body may be folded into a loop and secured in order to form the bracelet.

5. The identification bracelet of claim 4, wherein the signal-transmitting device is adhered to the main body.

6. The identification bracelet of claim 4, wherein the signal-transmitting device is enclosed into the main body.

7. The identification bracelet of claim 4, wherein the signal-transmitting device is a RFID transmitter.
